(19) United States
(12) Patent Application Publication
(10) Pub. No.: US 2020/0176838 A1
(43) Pub. Date: Jun. 4, 2020

(54) BATTERY MODULE

(71) Applicant: Robert Bosch GmbH, Stuttgart (DE)

(72) Inventors: Benjamin Kopp, Remseck Am Neckar (DE); Markus Schmitt, Tamm (DE)

(21) Appl. No.: 16/702,670

(22) Filed: Dec. 4, 2019

(30) Foreign Application Priority Data
Dec. 4, 2018 (DE) 10 2018 220 937.5

(51) Int. Cl. H01M 10/6566; H01M 2/10; H01M 10/613; H01M 10/625; H01M 10/647

(52) U.S. Cl. CPC H01M 10/6566; H01M 2/1077; H01M 2220/20; H01M 10/625; H01M 10/647; H01M 10/613

(57) ABSTRACT

A battery module with a plurality of battery cells (2), especially lithium ion battery cells (20), which are accommodated in a receiving space (6) formed by a housing (5) of the battery module (1), wherein the housing (5) of the battery module (1) furthermore forms a receiving element (7) designed to accommodate a cover plate (8), wherein a cover plate (8) is accommodated in the receiving element (7) in such a way that the cover plate (8) and the housing (5) form a flow space (9) through which a temperature-control fluid can flow, wherein the housing (5) of the battery module (1) furthermore separates the flow space (9) from the receiving space (6) in a fluid-tight manner.

### BACKGROUND OF THE INVENTION

The invention relates to a battery module.

It is known in the prior art that battery modules may consist of a plurality of individual battery cells, which can be electrically conductively interconnected in series and/or in parallel.

Hybrid-powered electric vehicles (HEV) and also electrically powered vehicles (EV) require high-energy and high-power battery systems in order for their electrical drive machines to reach the proper driving performance.

Usually high-energy and high-power lithium ion or lithium polymer battery cells are used here as the electrical energy accumulator, approximately 100 battery cells being interconnected to form a battery module.

Such high-performance battery cells each have a power of around 90 ampere hours (Ah).

Especially in electrically operated vehicles or also in hybrid electric vehicles, as well as in stationary applications, battery systems are usually employed with a plurality of such battery modules.

Battery cells may be configured, for example, as prismatic battery cells or as cylindrical battery cells, while so-called pouch cells are also being used increasingly in the field of electromobility.

Lithium ion or lithium polymer battery cells become heated especially during the charging and discharging on account of chemical transformation processes.

The more powerful such a battery module is, the greater is the resultant heating, so that often efficient and active temperature-control systems are required, which can both heat and cool the battery cells.

It is known from the prior art that battery modules can have a cooling plate through which temperature-control fluid can flow, said cooling plates being designed to control the temperature of the battery cells of a battery module, i.e., to cool or also to heat them.

For example, the documents DE 20 2012 102 349 U1 and DE 10 2008 059 955 A1 show such cooling plates known in the prior art, which are formed in particular from a first plate element and from a second plate element connected by integral bonding to the first plate element.

### SUMMARY OF THE INVENTION

A battery module with a plurality of battery cells according to the invention offers the advantage that a flow space can reliably be formed which is separated in a fluid-tight manner from the plurality of battery cells of the battery module, so that the battery cells of the battery module can be reliably temperature-controlled by means of a temperature-control fluid flowing through the flow space.

For this, a battery module with a plurality of battery cells is provided according to the invention.

In particular, the plurality of battery cells are each configured as lithium ion battery cells.

The plurality of battery cells are accommodated in a receiving space formed by a housing of the battery module.

The housing of the battery module furthermore forms a receiving element designed to accommodate a cover plate.

A cover plate is accommodated in the receiving element in such a way that the cover plate and the housing form a flow space through which a temperature-control fluid can flow.

The housing of the battery module furthermore separates the flow space from the receiving space in a fluid-tight manner.

By means of the measures set forth in the dependent claims, advantageous modifications and improvements of the device indicated in the independent claim are possible.

It is expedient for the receiving element and/or the cover plate to respectively form flow guidance elements each protruding into the flow space.

The flow guidance elements are designed to disturb the flow of a temperature-control fluid flowing through the flow space.

By means of the introduction of flow guidance elements in the flow space, the temperature-control fluid flows around the flow guidance elements, whereby the flow can be influenced.

In this way, it is possible to increase the so-called Reynolds number of the flow by means of the flow guidance elements. Furthermore, this may in particular have the result that the flow of the temperature-control fluid flowing through the flow space changes from a laminar flow to a turbulent flow.

Thus, on the whole, a flow of the temperature-control fluid flowing through the flow space has the advantage that the heat transfer can be increased.

Furthermore, such flow guidance elements offer the advantage that a heat transfer surface between the flow space and the temperature-control fluid can be enlarged.

For example, it is possible in this way to form an optimized flow structure with a reduced pressure loss and an increased heat transfer.

It should be mentioned here that the flow guidance elements can be formed for example from the receiving element or also the flow guidance elements can be formed from the cover plate, for example.

Furthermore, however, it is also conceivable that both the receiving element and the cover plate form respective flow guidance elements.

The configuration of the flow guidance elements, especially those of the cover plate, can be accomplished for example by means of a deep drawing process.

The configuration of the flow guidance elements, especially those of the housing of the battery module, can be accomplished for example during production of the housing by means of a die-casting process.

Furthermore, it is possible for example for the receiving element to mechanically contact flow guidance elements formed from the cover plate and/or for the cover plate to mechanically contact flow guidance elements formed from the receiving element.

Of course, however, it is also especially preferably possible for the receiving element to be arranged at a spacing from the flow guidance elements formed from the cover plate and/or for the cover plate to be arranged at a spacing from the flow guidance elements formed from the receiving wall.

It is advantageous for the flow guidance elements to each have a cross section area arranged parallel to a longitudinal direction of the cover plate. In particular, a longitudinal direction of the cover plate should describe its largest extent.

Preferably, the cross section areas each have a circular, oval, droplet, rectangular, or square shape.

This affords the advantage that defined disturbances of the flow of a temperature-control fluid flowing through the flow space can be formed by means of a defined configuration of the cross section areas, so that on the whole a specific influencing of the flow is possible.

Expediently, the flow guidance elements are arranged in several rows.

A row comprises for example a plurality of spacing elements, whose centers of gravity preferably all lie on the same straight line, and where the centers of gravity of respectively adjacent spacing elements are all respectively arranged spaced apart at an equal spacing distance.

Furthermore, it is expedient for in particular the flow guidance elements having a cross section area with a circular shape to be arranged such that rows arranged adjacent to each other are respectively offset from each other.

By this it is meant that for example a flow guidance element of one row is arranged adjacent to two flow guidance elements of a neighboring row such that this has respectively the same distance from the two flow guidance elements of the neighboring row.

In other words, this may also mean that in each case four flow guidance elements can describe a parallelogram, for example.

Such a mutual arrangement of the flow guidance elements affords the advantage that the flow of a temperature-control fluid flowing through the flow space can be preferably disturbed in order to increase the heat transfer between the temperature-control fluid and the battery cells.

Furthermore, it is expedient for the flow guidance elements having a cross section area with a rectangular shape to be mutually arranged in several rows.

Flow guidance elements of two adjacent rows arranged adjacently to each other respectively are arranged to form an acute angle with each other.

By an acute angle is meant here an angle forming an opening between 0° and 90°.

Such a mutual arrangement of the flow guidance elements also affords the advantage that the flow of a temperature-control fluid flowing through the flow space can be preferably disturbed in order to increase the heat transfer between the temperature-control fluid and the cover plate.

It should be mentioned here that it is preferable for the flow guidance elements to be arranged in lesser density or number in marginal areas of the flow space or for no flow guidance elements to be arranged there, so that flow dead zones of the flow of the temperature-control fluid can be reduced by means of a greater volume flow due to a lesser pressure loss.

It is advantageous for a sealing element to be arranged between the cover plate and the housing of the battery module.

This affords the advantage that a reliable sealing of the flow space with respect to the surroundings of the battery module can be formed.

According to one preferred aspect of the invention, the cover plate is joined by integral bonding to the receiving element.

A preferred integral bonding can be formed here for example by welding or also by soldering.

On the whole, an integrally bonded connection affords the advantage that a reliable connection can be formed between the cover plate and the receiving element.

It is expedient for the cover plate and/or the housing of the battery module to comprise a first port and a second port.

The first port is designed for a flowing of temperature-control fluid into the flow space.

The second port is designed for a flowing of temperature-control fluid out from the flow space.

This affords the advantage that the flow space can be connected fluidically conductively to the cooling circuit of a vehicle, for example.

According to an expedient aspect of the invention, the plurality of battery cells is arranged directly on a side of the receiving element of the housing of the battery module situated opposite the flow space.

In this way it is possible for heat from the plurality of battery cells to be released in a reliable manner to a temperature-control fluid flowing through the flow space yet at the same time also to form a fluid-tight separation by means of the housing between the battery cells and the flow space.

Expediently, the receiving element forms a bottom of the battery module.

A bottom of the battery module should be arranged on its lower side in a typical arrangement of the battery module.

### BRIEF DESCRIPTION OF THE DRAWINGS

Exemplary embodiments of the invention are presented in the drawings and shall be explained more closely in the following description.

There are shown:

FIG. 1 in a perspective top view, a battery module according to the invention,

FIG. 2A in a perspective bottom view, a first embodiment of a battery module according to the invention,

FIG. 2B in a perspective bottom view, the first embodiment of the battery module according to the invention of FIG. 2A in an exploded representation,

FIG. 3A in a perspective bottom view, a second embodiment of a battery module according to the invention,

FIG. 3B in a perspective bottom view, the second embodiment of the battery module according to the invention of FIG. 3A in an exploded representation,

FIG. 4A another embodiment of a cover plate,

FIG. 4B yet another embodiment of a cover plate,

FIG. 5 in a perspective bottom view, a housing of a battery module and

FIG. 6 in a side view, a cross sectional view of a battery module according to the invention.

### DETAILED DESCRIPTION

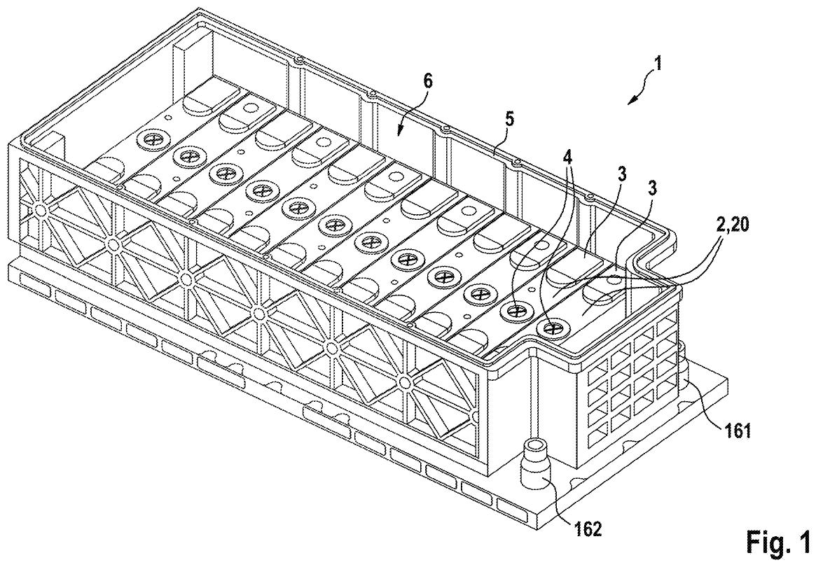

FIG. 1 shows in a perspective top view a battery module 1 according to the invention.

The battery module 1 comprises a plurality of battery cells 2, which in the exemplary embodiment shown in FIG. 1 are preferably designed as lithium ion battery cells 20.

The battery cells 2 each comprise voltage taps 3, for example, by means of which the battery cells 2 can be electrically interconnected in series and/or in parallel to cell connectors not shown in FIG. 1.

Furthermore, the battery cells 2 each comprise a degassing element 4, for example, which may serve for releasing gas from the battery cells 2 during safety-critical situations.

The battery module 1 furthermore comprises a housing 5.

The housing 5 of the battery module 1 forms a receiving space 6 in which the plurality of battery cells 2 is accommodated.

It is possible for the housing 5 of the battery module 1 to be closed by means of a lid element, not shown in FIG. 1, so that the receiving space 6 is completely sealed off with respect to the surroundings of the battery module 1.

It should already be mentioned here that the battery module 1 comprises a first port 161 and a second port 162 by means of which temperature-control fluid can flow into or out from a flow space 9 of the battery module 1, not visible in FIG. 1.

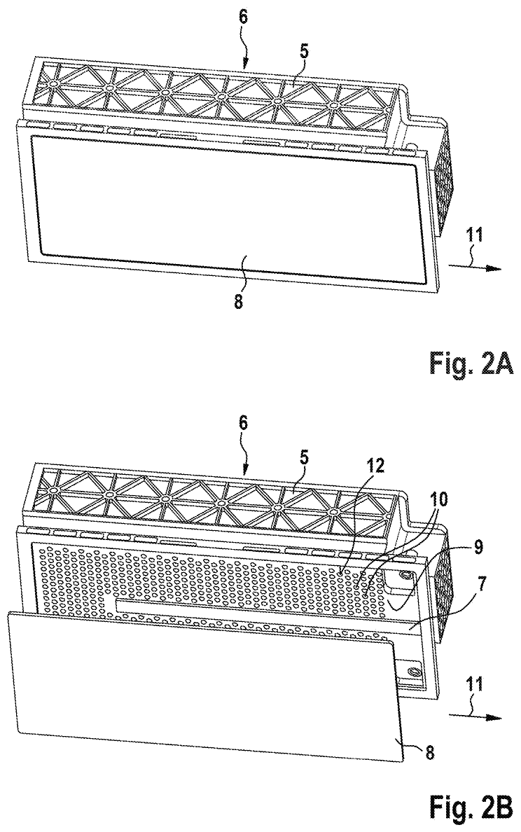

FIG. 2A shows in a perspective bottom view a first embodiment of a battery module 1 according to the invention.

FIG. 2B shows in a perspective bottom view the first embodiment of the battery module 1 according to the invention of FIG. 2A in an exploded representation.

The first embodiment of the battery module 1 according to the invention shall now be described with the aid of FIGS. 2A and 2B together.

It can be seen that the housing 5 of the battery module 1 furthermore forms a receiving element 7, which is designed to accommodate a cover plate 8.

In particular, FIG. 2A shows that the cover plate 8 is accommodated in the receiving element 7.

The cover plate 8 and the housing 5 or the receiving element 7 form a flow space 9 through which temperature-control fluid can flow.

Furthermore, it is especially evident from FIG. 2B that the housing 5 of the battery module 1 furthermore separates the flow space 9 in a fluid-tight manner from the receiving space 6.

FIGS. 2A and 2B show a first embodiment of the battery module 1, in which the receiving element 7 forms flow guidance elements 10 respectively protruding into the flow space 9.

The flow guidance elements 10 are designed to disturb a flow of a temperature-control fluid flowing through the flow space 9.

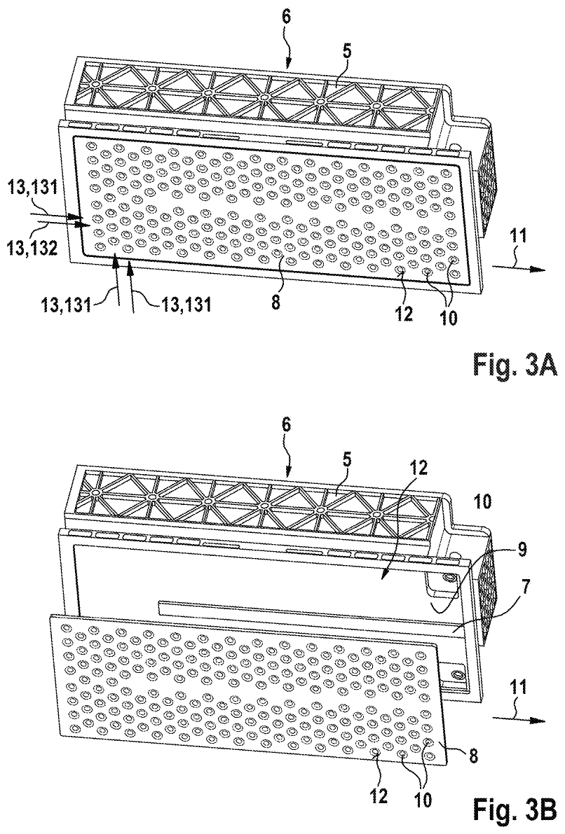

FIG. 3A shows in a perspective bottom view a second embodiment of a battery module 1 according to the invention.

FIG. 3B shows in a perspective bottom view the second embodiment of the battery module 1 according to the invention of FIG. 3A in an exploded representation.

The second embodiment of the battery module 1 according to the invention shall now be described with the aid of FIGS. 3A and 3B together.

The second embodiment of the battery module 1 of FIGS. 3A and 3B differs from the first embodiment of the battery module 1 shown in FIGS. 2A and 2B in that it is not the receiving element 7 which forms flow guidance elements 10 respectively protruding into the flow space 9 but rather the cover plate 8 which forms flow guidance elements 10 respectively protruding into the flow space 9.

The flow guidance elements 10 are designed to disturb a flow of a temperature-control fluid flowing through the flow space 9. Otherwise, the first embodiment of the battery module 1 and the second embodiment of the battery module 1 are identical, so that a description of elements already described in connection with FIGS. 2A and 2B shall not be given here.

In particular, it can be seen from FIGS. 2B, 3A, 3B that the flow guidance elements 10 have a cross section area 12 arranged parallel to a longitudinal direction 11 of the cover plate 8.

The cross section area 12 according to the first embodiment of the battery module 1 according to the invention and the second embodiment of the battery module 1 according to the invention has a circular shape in each case.

For example, it can be seen from FIG. 3A that the flow guidance elements 10 are arranged in multiple rows 13.

In particular, rows 13 arranged adjacently to each other are arranged offset from one another.

In the exemplary embodiment of FIG. 3A, a first row 131 is arranged offset from a second row 132.

Furthermore, it is also evident from FIG. 3A that the rows 13 may be arranged both running in the direction of the longitudinal direction 11 of the cover plate 8 and running perpendicular to the direction of the longitudinal direction 11 of the cover plate 8.

It should be mentioned here that the arrangement of the flow guidance elements 10 in multiple rows is not confined to the exemplary embodiment of FIG. 3A, but is merely described as an example with the aid of FIG. 3A.

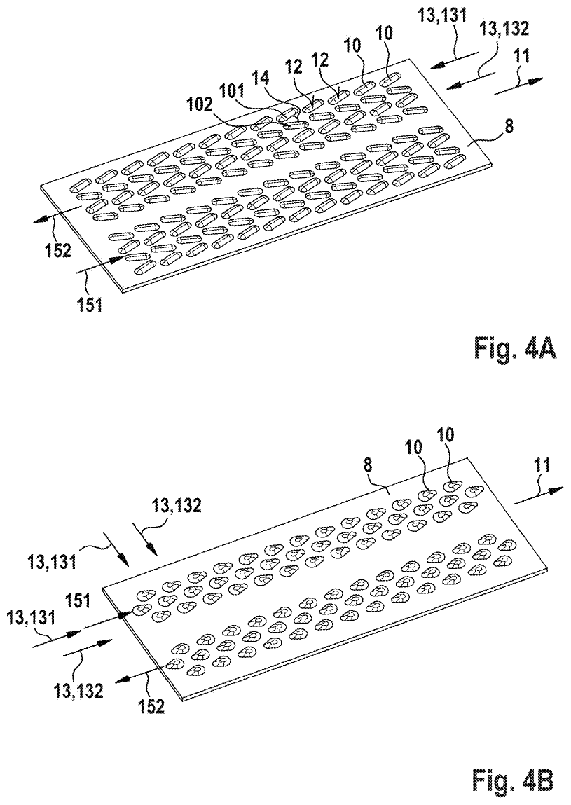

FIGS. 4A and 4B respectively show further embodiments of cover plates 8. FIGS. 4A and 4B show embodiments in which the cover plate 8 forms the flow guidance elements 10.

FIG. 4A shows an embodiment of a cover plate 8 in which the flow guidance elements 10 have a cross section area 12 with a substantially rectangular shape.

The flow guidance elements 10 are arranged in multiple rows 13.

Adjacently arranged flow guidance elements 10 which are arranged in each case in two directly adjacently arranged rows 13 in each case make an acute angle 14 with each other.

In particular, a first flow guidance element 101 arranged in a first row 131 and a second flow guidance element 102 arranged in a second row 132 together form an acute angle 14.

The arrow with the reference number 151 denotes the direction of a temperature-control fluid flowing into the flow space 9 and the arrow with the reference number 152 denotes the direction of a temperature-control fluid flowing out from the flow space 9.

FIG. 4B shows an embodiment of a cover plate 8 in which the flow guidance elements 10 have a droplet shape of the cross section area 12.

For example, it can be seen from FIG. 4B that the flow guidance elements 10 are arranged in multiple rows 13.

In particular, rows 13 arranged adjacently to each other are arranged offset from one another.

In the exemplary embodiment of FIG. 4B, a first row 131 is arranged offset from a second row 132.

Furthermore, it is also evident from FIG. 4B that the rows 13 may be arranged both running in the direction of the longitudinal direction 11 of the cover plate 8 and running perpendicular to the direction of the longitudinal direction 11 of the cover plate 8.

It should be mentioned here that the arrangement of the flow guidance elements 10 in multiple rows 13 is not confined to the exemplary embodiment of FIG. 4B.

The arrow with the reference number 151 denotes the direction of a temperature-control fluid flowing into the flow space 9 and the arrow with the reference number 152 denotes the direction of a temperature-control fluid flowing out from the flow space 9.

It is furthermore evident that temperature-control fluid preferably flows against the flow guidance elements 10 from a relatively broad side of the droplet shape.

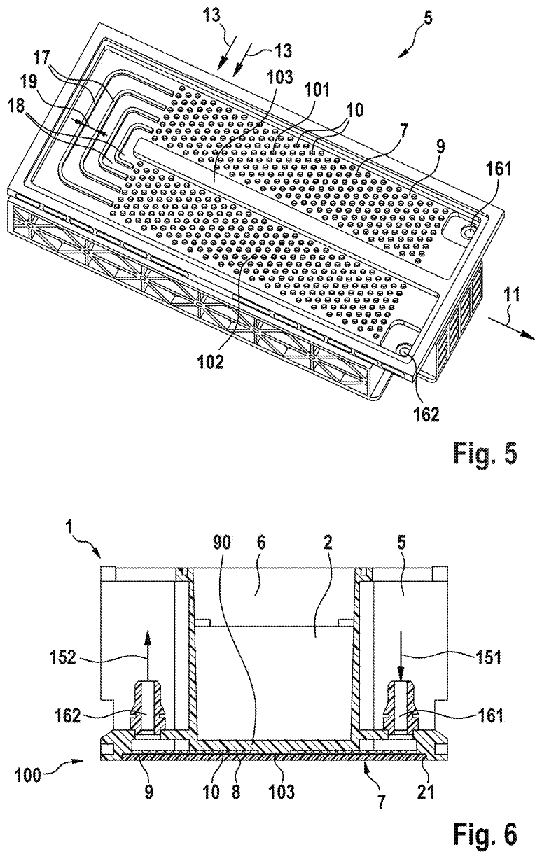

FIG. 5 shows in a perspective bottom view a housing 5 of a battery module 1.

The embodiment of the housing 5 shown in FIG. 5 is configured such that the receiving element 7 of the housing 5 forms flow guidance elements 10 protruding into the flow space 9, which are designed to disturb the flow of a temperature-control fluid flowing through the flow space 9.

FIG. 5 shows that the housing 5 of the battery module 1 may have a first port 161 and a second port 162.

The first port 161 is designed for a flowing of temperature-control fluid into the flow space 9 and the second port 162 is designed for a flowing of temperature-control fluid out from the flow space 9.

It should be noted here once more that the flow guidance elements 10, as already mentioned in connection with the first embodiment of the battery module 1 of FIGS. 2A and 2B and the second embodiment of the battery module 1 per FIGS. 3A and 3B, are arranged in multiple rows 13 relative to each other, and adjacently arranged rows 13 are arranged from each other.

The embodiment of the flow space 9 shown in FIG. 5 differs from the embodiments of the flow space described heretofore of FIGS. 1 to 4 in that the flow space 9 also comprises deflecting elements 17 besides the spacing elements 10, which serve to deflect the direction of flow of the temperature-control fluid.

For example, temperature-control fluid flows through the first port 161 into the flow space 9 and flows substantially counter to the longitudinal direction 11 of the cover plate through a first plurality 101 of flow guidance elements 10.

The deflecting elements 17 then reverse the direction of flow of the temperature-control fluid, so that the temperature-control fluid flows substantially in the direction of the longitudinal direction 11 of the cover plate 9 through a second number 102 of spacing elements 10 and flows through the second port 162 out from the flow space 9.

It should also be noted here that a separating element 103 separates the first number 101 of flow guidance elements 10 from the second number 102 of flow guidance elements 10.

According to the exemplary embodiment of FIG. 5, the housing 5 of the battery module 1 forms a plurality of deflecting elements 17, which thus also together form a plurality of deflecting ducts 18. It should be noted that a duct width 19 of the deflecting ducts 18 increases in the direction of an edge of the flow space 9, in order to form a uniform pressure loss inside the deflecting ducts 18.

FIG. 6 shows in a side view a cross sectional view of a battery module 1 according to the invention.

In particular, the housing 5 of the battery module 1 of FIG. 6 is formed according to the housing 5 shown in FIGS. 1, 2A, 2b, 3A, 3B, 5.

One can see in particular the first port 161, which is designed for a flow of temperature-control fluid into the flow space 9, and the second port 162, which is designed for a flow of temperature-control fluid out from the flow space 9.

Here as well, the arrow with the reference number 151 denotes incoming temperature-control fluid and the arrow with the reference number 152 denotes outgoing temperature-control fluid.

Furthermore, a battery cell 2 and its voltage taps 3 can also be seen.

The housing 5 of the battery module 1 forms the receiving element 7. Furthermore, the receiving element 7 of the housing 5 accommodates the cover plate 8. In particular, the cover plate 8 and the receiving element 7 are joined together by integral bonding. For example, the integral bonding may be formed by a welding or a soldering. Preferably, the integral bond is situated encircling a marginal region 21 of the cover plate 8 or the receiving element 7 and/or on the separating element 103 of the cover plate 8 or the receiving element 7.

It is possible furthermore for a sealing element not shown in the figures to be arranged between the cover plate 8 and the housing 5 of the battery module 1 or the receiving element 7 of the battery module.

The receiving element 7 of the housing 5 of the battery module 1 and the cover plate 8 together form the flow space 9.

Hence, the flow space 9 is thus formed between the receiving element 7 of the housing 5 of the battery module 1 and the cover plate 8.

Furthermore, FIG. 6 also shows flow guidance elements 10, which are formed for example from the receiving element 7 in the exemplary embodiment shown in FIG. 6. Of course, however, it is also possible for the cover plate 8 to form the flow guidance elements 10.

Furthermore, the housing 5 of the battery module 1 separates the flow space 9 in a fluid-tight manner from the receiving space 6 in which the plurality of battery cells 2 is accommodated. In particular, the receiving element 7 itself can provide for such a fluid-tight separation.

Moreover, it should be noted in connection with FIG. 6 that the plurality of batteries 2 is arranged directly on a side 90 of the receiving element 7 of the housing 5 of the battery module 1 situated opposite the flow space 9.

It is also especially evident from FIG. 6 that the receiving element 7 forms a bottom 100 of the battery module 1 in particular together with the cover plate 8.

It should further be noted here that the figures shown are meant to serve only as an explanation of the battery module according to the invention, and should in no way limit the invention.

For example, it is also possible for the embodiments of the cover plates 8 shown in FIGS. 4A and 4B to also be formed analogously by a receiving element 7 of the housing 5 of the battery module 1.

Moreover, it is also possible for the embodiment of the receiving element 7 shown in FIG. 5 with flow guidance elements 10 and deflecting elements 17 to also be formed analogously by a cover plate 8.

1. A battery module with a plurality of battery cells (2) accommodated in a receiving space (6) formed by a housing (5) of the battery module (1), wherein the housing (5) of the battery module (1) furthermore forms a receiving element (7) configured to accommodate a cover plate (8) in such a way that the cover plate (8) and the housing (5) form a flow space (9) configured to have a temperature-control fluid flow therethrough, wherein the housing (5) of the battery module (1) furthermore separates the flow space (9) from the receiving space (6) in a fluid-tight manner.

2. The battery module according to the preceding claim 1,
characterized in that
the receiving element (7) and/or the cover plate (8) respectively form flow guidance elements (10) protruding into the flow space (9) to disturb flow of the temperature-control fluid flowing through the flow space (9).

3. The battery module according to the preceding claim 2,
characterized in that
the flow guidance elements (10) have a cross section area (12) arranged parallel to a longitudinal direction (11) of the cover plate (8), wherein the cross section area (12) has a circular, oval, droplet, rectangular, or square shape.

4. The battery module according to the preceding claim 3,
characterized in that
the flow guidance elements (10) are arranged in several rows (13), and rows (13, 131,132) arranged adjacently to each other are offset from each other.

5. The battery module according to the preceding claim 3,
characterized in that
the flow guidance elements (10) with a cross section area (12) having a rectangular shape are arranged in several rows (13), wherein flow guidance elements (10) of two adjacent rows (13) arranged adjacently to each other respectively are arranged to form an acute angle (14) with each other.

6. The battery module according to claim 1,
characterized in that
a sealing element is furthermore arranged between the cover plate (8) and the housing (5) of the battery module (1).

7. The battery module according to claim 1,
characterized in that
the cover plate (8) is joined by integral bonding to the receiving element (7).

8. The battery module according to claim 1,
characterized in that
the cover plate (8) and/or the housing (5) of the battery module (1) comprise(s) a first port (161) configured for flow of temperature-control fluid into the flow space (9) and a second port (162) configured for flow of temperature-control fluid out from the flow space (9).

9. The battery module according to claim 1,
characterized in that
the plurality of battery cells (2) is arranged directly on a side (90) of the receiving element (7) of the housing (5) of the battery module (1) situated opposite the flow space (9).

10. The battery module according to claim 1,
characterized in that
the receiving element (7) forms a bottom (100) of the battery module (1).

11. The battery module according to the preceding claim 3,
characterized in that
the flow guidance elements (10) with a cross section area (12) having a circular shape are arranged in several rows (13), and rows (13, 131,132) arranged adjacently to each other are offset from each other.

12. The battery module according to claim 1,
characterized in that
the cover plate (8) is joined by soldering to the receiving element (7).
